(19) United States
(12) Patent Application Publication
(10) Pub. No.: US 2015/0195599 A1
(43) Pub. Date: Jul. 9, 2015

(54) METHODS FOR SYNCHRONIZATION OF A LIVE STREAMING BROADCAST AND SYSTEMS USING THE SAME

(71) Applicant: Wistron Corp., New Taipei City (TW)

(72) Inventor: Chih-An SU, New Taipei City (TW)

(21) Appl. No.: 14/453,552

(22) Filed: Aug. 6, 2014

(30) Foreign Application Priority Data
Jan. 7, 2014 (TW) 103100477

(51) Int. Cl. H04N 21/262; H04N 21/226; H04N 21/433; H04N 21/266; H04N 21/242; H04N 21/8547; H04N 21/2187; H04N 21/237

(52) U.S. Cl. CPC H04N 21/26258; H04N 21/2187; H04N 21/2265; H04N 21/237; H04N 21/26603; H04N 21/242; H04N 21/8547; H04N 21/4334

(57) ABSTRACT

An embodiment of the invention introduces a method for a live streaming broadcast, executed by a processing unit of a live streaming broadcast server, which contains at least the following steps. A refresh time of a new version of a second-layer playlist is recorded in the second-layer playlist. The second-layer playlist is provided, thereby enabling a client to start updating the second-layer playlist and download an up-to-date file download when time reaches the refresh time recorded in the second-layer playlist.

### CROSS REFERENCE TO RELATED APPLICATIONS

This Application claims priority of Taiwan Patent Application No. 103100477, filed on Jan. 7, 2014, the entirety of which is incorporated by reference herein.

### BACKGROUND

1. Technical Field

The present invention relates to a live streaming broadcast, and in particular, to methods for synchronization of a live streaming broadcast and systems using the same.

2. Description of the Related Art

Live streaming broadcast, such as HLS (HTTP Live Streaming, known as HLS), operates by breaking the overall stream into a sequence of small file downloads, each download loading one short chunk of an overall potentially unbounded transport stream. However, the playback progress for the same live streaming may be inconsistent among clients downloading and starting to play at different moments. Thus, it is desirable to have methods for synchronization of a live streaming broadcast and systems using the same to reduce the aforementioned inconsistency of the playback progress as much as possible.

### BRIEF SUMMARY

An embodiment of the invention introduces a method for synchronization of a live streaming broadcast, executed by a processing unit of a live streaming broadcast server, which contains at least the following steps. A refresh time of a new version of a second-layer playlist is recorded in the second-layer playlist. The second-layer playlist is provided, thereby enabling a client to start updating the second-layer playlist and download an up-to-date file download when time reaches the refresh time recorded in the second-layer playlist.

An embodiment of the invention introduces a method for synchronization of a live streaming broadcast, executed by a processing unit of a client, which contains at least the following steps. A second-layer playlist is obtained from a live streaming broadcast server. A refresh time recorded in the second-layer playlist is obtained. An up-to-date second-layer playlist is obtained from the live streaming broadcast server when time reaches the refresh time.

An embodiment of the invention introduces a system for synchronization of a live streaming broadcast, which contains at least a live streaming broadcast server. The live streaming broadcast server records a refresh time of a new version of a second-layer playlist in the second-layer playlist, and provides the second-layer playlist, thereby enabling a client to start updating the second-layer playlist and download an up-to-date file download when time reaches the refresh time recorded in the second-layer playlist.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 is a schematic diagram of the network architecture according to an embodiment of the invention;

FIG. 2 is the system architecture of a computer according to an embodiment of the invention;

FIGS. 3A and 3B are flowcharts illustrating a method for synchronization of a live streaming broadcast, performed by a processing unit of a live streaming broadcast server when relevant software codes and/or instructions are loaded and executed, according to an embodiment of the invention; and

FIG. 4 is a flowchart illustrating a method for synchronization of live streaming broadcast, performed by a processing unit of a client when relevant software codes and/or instructions of a playback application are loaded and executed, according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

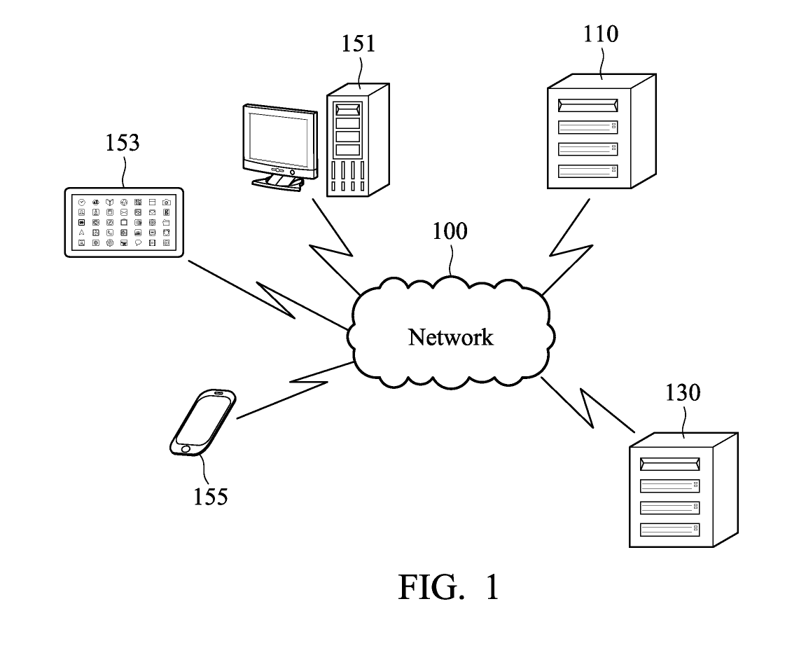

An embodiment of the invention introduces network architecture containing multiple servers and clients operating in a live streaming broadcast environment. FIG. 1 is a schematic diagram of the network architecture according to an embodiment of the invention. An NTP (Network Time Protocol) server 110, a live streaming broadcast server 130, a desktop computer 151, a tablet computer 153 and a mobile phone 155 may be in communication with each other via the network 100, where the network may be the Internet, a wired LAN (Local Area Network), a WLAN (wireless LAN) or any combination thereof. The NTP server 110 synchronizes all participating computers to within a few milliseconds of Coordinated Universal Time (UTC). The 64-bit timestamps used by NTP consist of a 32-bit part for seconds and a 32-bit part for fractions of a second. After receiving a request from a server or a client, such as the live streaming broadcast server 130, the desktop computer 151, the tablet computer 153 or the mobile phone 155, etc., the NTP server 110 delivers the current time stamp in response. The server or the client may periodically request the NTP server 110 and adjust its system clock according to the replied time stamp to synchronize its time with other computers. The live streaming broadcast server 130, such as a HLS (HyperText Transport Protocol Live Streaming) server, breaks the overall stream into a sequence of small file downloads, each download loading one short chunk of an overall potentially unbounded transport stream for a predefined time period, for example, ten seconds. When the stream is played, the client may select from a number of different alternate streams containing the same material encoded at different data rates, which are stated in a first-layer playlist, enabling the streaming session to adapt to the available data rate. At the start of the download session, the client downloads a second-layer playlist from the live streaming broadcast server 130, such as an extended M3U (.m3u8) playlist, containing the metadata for the current file download, which is available to play, and the next file downloads to be prepared. The second-layer playlist provides information regarding times encoding the file downloads.

An exemplary HLS first-layer playlist is provided as follows:
#EXTM3U
#EXT-X-STREAM-INF:PROGRAM-ID=1,BANDWIDTH=128000
http://ALPHA.example.com/low/low_index.m3u8
#EXT-X-STREAM-INF:PROGRAM-ID=1,BANDWIDTH=128000
http://BETA.example.com/low/low_index.m3u8
#EXT-X-STREAM-INF:PROGRAM-ID=1,BANDWIDTH=128000
http://GAMMA.example.com/low/low_index.m3u8
#EXT-X-STREAM-INF:PROGRAM-ID=1,BANDWIDTH=256000
http://ALPHA.example.com/mid/mid_index.m3u8
#EXT-X-STREAM-INF:PROGRAM-ID=1,BANDWIDTH=256000
http://BETA.example.com/mid/mid_index.m3u8
#EXT-X-STREAM-INF:PROGRAM-ID=1,BANDWIDTH=768000
http://ALPHA.example.com/high/high_index.m3u8
#EXT-X-STREAM-INF:PROGRAM-ID=1,BANDWIDTH=768000
http://BETA.example.com/high/high_index.m3u8
#EXT-X-STREAM-INF:PROGRAM-ID=1,BANDWIDTH=64000
http://GAMMA.example.com/audio/audio_index.mp3
   The first-layer playlist describes the qualities of file downloads delivered by the ALPHA, BETA and GAMMA servers, respectively, and the URLs (Uniform Resource Locator—so-called network addresses for accessing the second-layer playlists of the ALPHA, BETA and GAMMA servers, respectively. It should be noted that the ALPHA, BETA and GAMMA servers may be practiced in virtual machines executed in a processing unit of the live streaming broadcast server 130. Besides, the ALPHA, BETA and GAMMA servers may be implemented in different physical enclosures, and the invention should not be limited thereto. It should be understood by referring to the exemplary first-layer playlist that both the ALPHA and BETA servers provide the low-, medium- and high-quality live streaming broadcasts while the GAMMA server acting as a backup server only provides the low-quality live streaming broadcast and the pure audio streaming. The location of the requisite second-layer playlist is known by any client after parsing the first-layer playlist. The client may obtain the requisite second-layer playlist accordingly. Details of the second-layer playlist may be described further in the following passages.

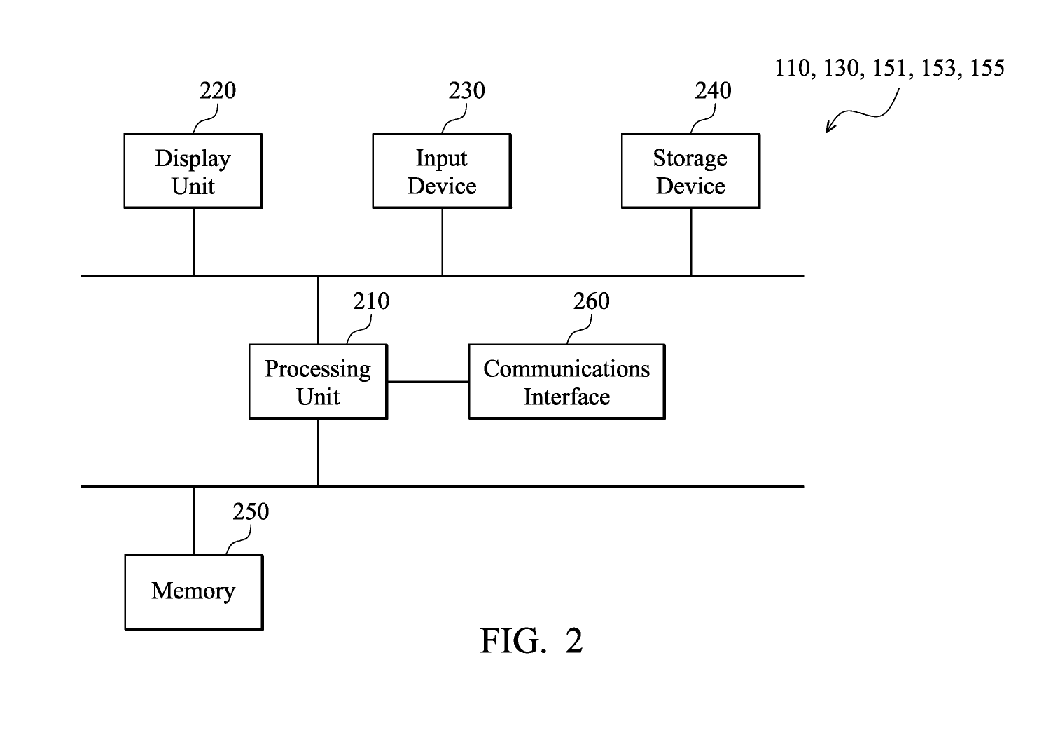

FIG. 2 is the system architecture of a computer according to an embodiment of the invention. The system architecture may be practiced in any of the NTP server 110, the live streaming broadcast server 130, the desktop computer 151, the tablet computer 153 and the mobile phone 153, at least including a processing unit 210. The processing unit 210 can be implemented in numerous ways, such as with dedicated hardware, or with general-purpose hardware (e.g., a single processor, multiple processors or graphics processing units capable of parallel computations, or others) that is programmed using microcode or software instructions to perform the functions recited herein. The system architecture further includes a memory 250 for storing necessary data in execution, such as variables, data tables, or others, and a storage unit 240 for storing a wide range of electronic files, such as Web pages, documents, video files, audio files, or others. A communications interface 260 is included in the system architecture and the processing unit 210 can thereby communicate with other electronic devices. The communications interface 260 may be a LAN communications module, a WLAN communications module, a wireless telecommunications module having modems supporting arbitrary combinations of the 2G, 3G, 4G and the higher-generation technology, or any combination thereof. The system architecture further includes one or more input devices 230 to receive user input, such as a keyboard, a mouse, a touch panel, or others. A user may press hard keys on the keyboard to input characters, control a mouse pointer on a display by operating the mouse, or control an executed application with one or more gestures made on the touch panel. The gestures include, but are not limited to, a single-click, a double-click, a single-finger dragging, and a multiple finger dragging. A display unit 220, such as a TFT-LCD (Thin film transistor liquid-crystal display) panel, an OLED (Organic Light-Emitting Diode) panel, or others, may also be included to display input letters, alphanumeric characters and symbols, dragged paths, drawings, or screens provided by an application for a user's viewing.

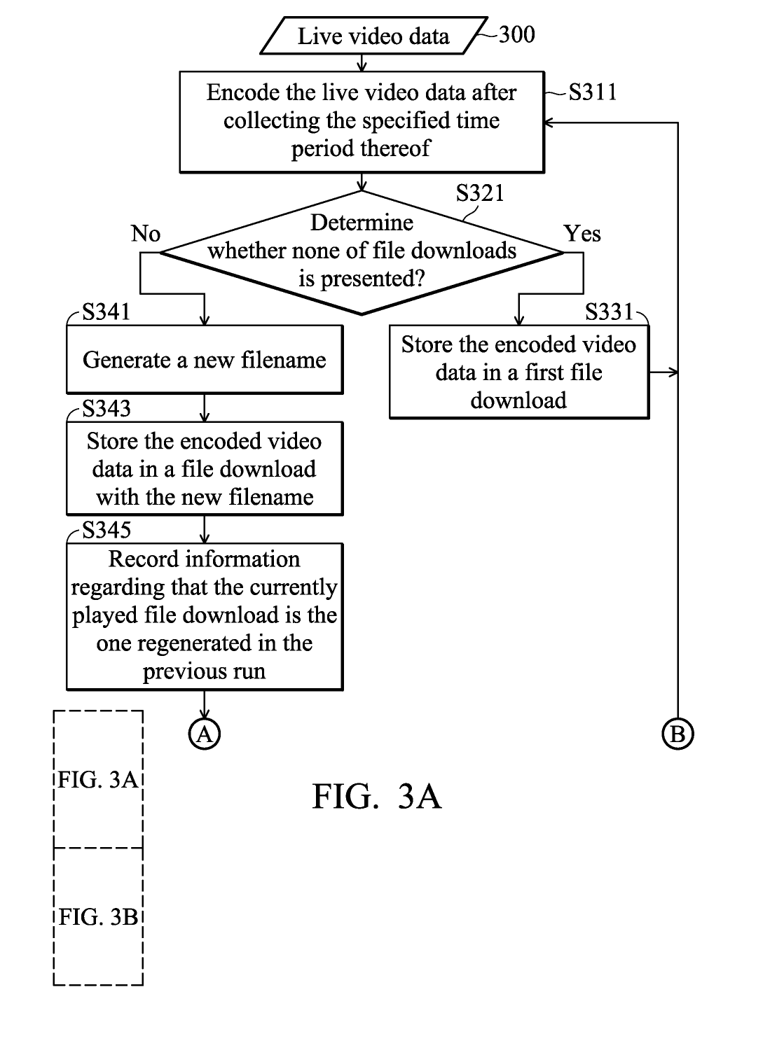

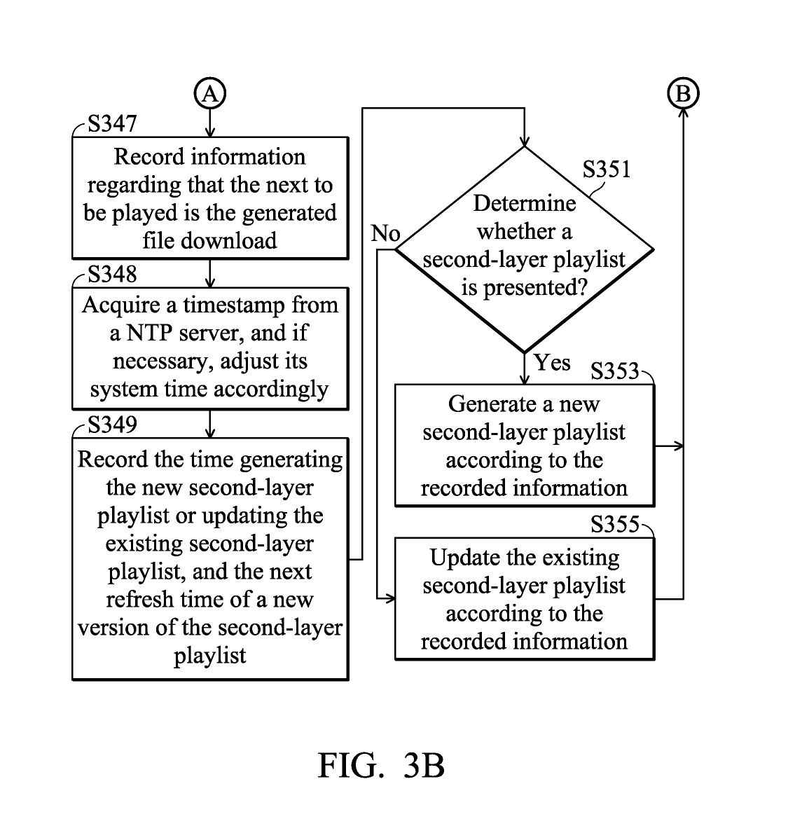

FIGS. 3A and 3B are flowcharts illustrating a method for synchronization of a live streaming broadcast, performed by the processing unit 210 of the live streaming broadcast server 130 when relevant software codes and/or instructions are loaded and executed, according to an embodiment of the invention. The live streaming broadcast server 130 repeatedly receives live video data 300, and encodes the data to generate a new file download as long as a specified time period of the live video data 300 has been collected. Subsequently, a new second-layer playlist is generated or the existing second-layer playlist is updated to enable a client to obtain the generated file download. The method is performed in cases where the serving server and the resolution of the file downloads have been determined. For example, the high-resolution file downloads have been decided to be delivered by the ALPHA server. The process periodically starts to encode the live video data 300 after collecting the specified time period of that, e.g. 10 seconds (step S311). The live streaming broadcast server 130 may implement known video compression techniques, such as those described in the standards defined by MPEG-2, MPEG-4, ITU-T H.263, ITU-T H.264, AVC (Advanced Video Coding), HEVC (High Efficiency Video Coding), and extensions of such standards. Then, it is determined whether none of the file downloads is presented (step S321). If so, the encoded video data is stored in a first file download (step S331). Filenames of the generated file downloads may contain serial numbers, for example, “1” of a filename “FileSequence_{—}1.ts” indicates that this is the first generated file download.

When any file download is presented (the “no” path of step S321), a new filename is generated by following a predefined naming rule (step S341), and the encoded video data is stored in a file download with the new filename (step S343). Subsequently, information regarding the currently playing file download being the one generated in the previous run is recorded in the memory 250 (step S345), and information regarding the next to be played being the generated file download is also recorded in the memory 250 (step S347). Those skilled in the art may practice two variables to record the aforementioned information. A timestamp is acquired from the NTP server 110, and if necessary, the system time of the live streaming broadcast server 130 is adjusted accordingly (step S348). Following that, the time generating the new second-layer playlist or updating the existing second-layer playlist, and the next refresh time of a new version of the second-layer playlist are recorded in the memory 250 (step S349). It should be noted that the time generating or updating the second-layer playlist is substantially close to the time generating the new file download, and the next refresh time to update the second-layer playlist will be substantially close to the time to generate the next file download.

After the new file download has been generated and the necessary information has been recorded (steps S341 to S349), it is determined whether a second-layer playlist is presented (step S351). If not, a new second-layer playlist is generated according to the recorded information (step S355). It will be known by those skilled in the art that when the process goes to step S355, the generated file download in step S343 is the second file download. An exemplary HLS second-layer playlist is provided as follows:
#EXTM3U
#EXT-EVENT-NTP:ntp1.org
#EXT-X-PLAYLIST-TYPE:EVENT
#EXT-X-TARGETDURATION:10
#EXT-X-MEDIA-SEQUENCE:0
#EXT-EVENT-PLAYLIST-NEXT-BORN: Thu Jul 28 15:33:38 CST 2013
#EXT-EVENT-PLAYLIST-BORN: Thu Jul 28 15:33:28 CST 2013
#EXT-EVENT-PLAYLIST-FILE:FileSequence_{—}1.ts
#EXT-EVENT-PLAYLIST-NEXT-FILE:FileSequence_{—}2.ts
#EXTINF:10,
FileSequence_{—}1.ts
#EXTINF:10,
FileSequence_{—}2.ts
#EXTINF:10,
FileSequence_{—}3.ts
   The parameter “EXT-EVENT-NTP” defines the network address “ntp1.org” of the NTP server 110 used to synchronize system times among servers and clients. The parameter “EXT-EVENT-PLAYLIST-BORN” and “EXT-EVENT-PLAYLIST-NEXT-BORN” define this second-layer playlist as being generated at “Thu Jul 28 15:33:28 CST 2013” and the second-layer playlist will be updated at “Thu Jul 28 15:33:38 CST 2013”, respectively. In addition, a playback application executed in a client may know through the parameter “EXT-EVENT-PLAYLIST-FILE” that a file download named “FileSequence_Lts” is currently being played by the subscribing clients, and through the parameter “EXT-EVENT-PLAYLIST-NEXT-FILE” that a file download named “FileSequence_{—}2.ts” is available to be downloaded by the subscribing clients. The playback application will start to play the file download “FileSequence_{—}2.ts” defined in the parameter “EXT-EVENT-PLAYLIST-NEXT-FILE” at “Thu Jul 28 15:33:38 CST 2013” defined in the parameter “EXT-EVENT-PLAYLIST-NEXT-BORN”. In addition, all subscribing clients will start to obtain the updated second-layer playlist and a new file download “FileSequence_{—}3.ts” at “Thu Jul 28 15:33:38 CST 2013” defined in the parameter “EXT-EVENT-PLAYLIST-NEXT-BORN”.

When a second-layer playlist is presented (the “No” path of step S351), the second-layer playlist is updated according to the recorded information (step S353). It would be known by those skilled in the art, when the process goes to step S353, the generated file download in step S343 is the third file download or a subsequent one. The following demonstrates an exemplary scenario for the generation of the third file download. An updated HLS second-layer playlist is provided as follows:
#EXTM3U
#EXT-EVENT-NTP:ntp1.org
#EXT-X-PLAYLIST-TYPE:EVENT
#EXT-X-TARGETDURATION:10
#EXT-X-MEDIA-SEQUENCE:0
#EXT-EVENT-PLAYLIST-NEXT-BORN:Thu Jul 28 15:33:48 CST 2013
#EXT-EVENT-PLAYLIST-BORN:Thu Jul 28 15:33:38 CST 2013
#EXT-EVENT-PLAYLIST-FILE:FileSequence_{—}2.ts
#EXT-EVENT-PLAYLIST-NEXT-FILE:FileSequence_{—}3.ts
#EXTINF:10,
FileSequence_{—}2.ts
#EXTINF:10,
FileSequence_{—}3.ts
#EXTINF:10,
FileSequence_{—}4.ts
   The updated second-layer playlist suggests a file download named “FileSequence_{—}2.ts” is currently being played by the subscribing clients, and a file download named “FileSequence_{—}3.ts” is currently being downloaded by the subscribing clients. In addition, the subscribing clients will start to play the file download “FileSequence_{—}3.ts”, and obtain the updated second-layer playlist and a new file download “FileSequence_{—}4.ts” at “Thu Jul 28 15:33:48 CST 2013”. The parameter “EXT-EVENT-PLAYLIST-NEXT-BORN” is used to enable playback applications running in all subscribing clients to start playing the same file download at a very close moment, so as to reduce the inconsistency of playback progress among subscribing clients. It will be observed by those skilled in the art that information regarding the file download “FileSequence_{—}1.ts” having been played is removed from this second-layer playlist.

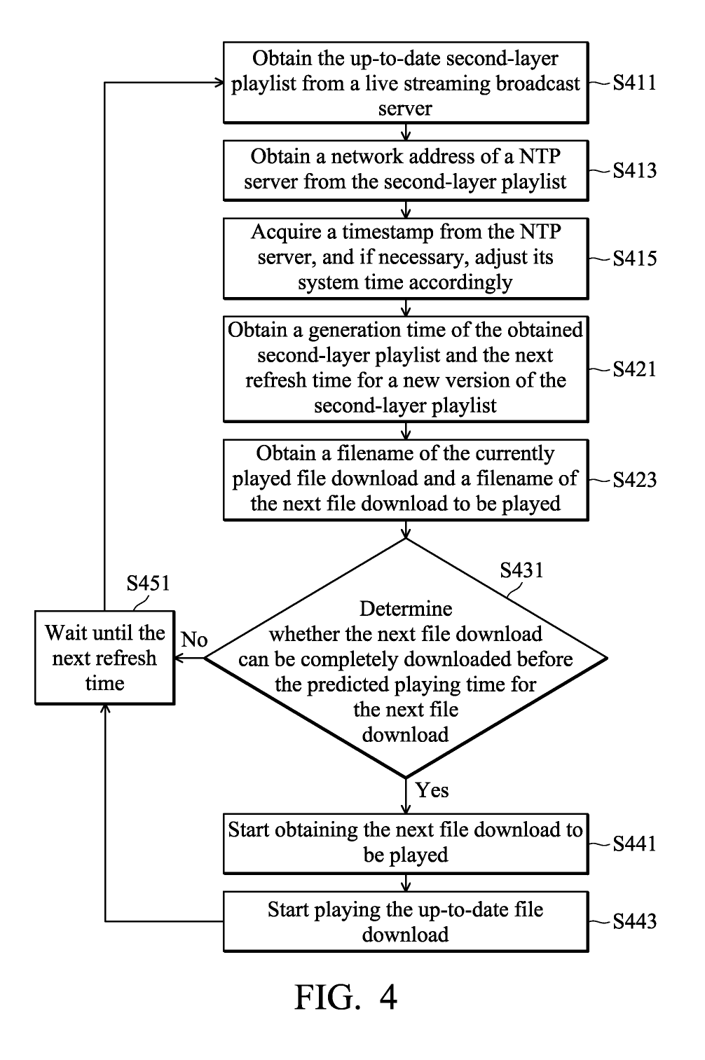

FIG. 4 is a flowchart illustrating a method for synchronization of a live streaming broadcast, performed by the processing unit 210 of the client 151, 153 or 155 when relevant software codes and/or instructions of a playback application are loaded and executed, according to an embodiment of the invention. The process periodically obtains the up-to-date second-layer playlist, and after parsing the content of the obtained second-layer playlist, starts playing the file download which has been completely downloaded and obtaining the next file download. Specifically, after the up-to-date second-layer playlist is obtained from the live streaming broadcast server 130 (step S411), a network address of the NTP server 110 is obtained from the second-layer playlist (step S413), a timestamp is acquired from the NTP server 110, and if necessary, the system time of the client is accordingly adjusted (step S415). In addition, the playback application obtains the generation time of the obtained second-layer playlist and the next refresh time for a new version of the second-layer playlist (step S421), and obtains a filename of the currently played file download and a filename of the next file download to be played (step S423). The generation time of the obtained second-layer playlist and the next refresh time for a new version of the second-layer playlist may be obtained by accessing the parameters “EXT-EVENT-PLAYLIST-BORN” and “EXT-EVENT-PLAYLIST-NEXT-BORN”, respectively. A filename of the currently played file download and a filename of the next file download to be played may be obtained by accessing the parameters “EXT-EVENT-PLAYLIST-FILE” and “EXT-EVENT-PLAYLIST-NEXT-FILE”, respectively.

Due to a client being able to perform a second-layer playlist download for the first time at an arbitrary moment, there is a need to determine whether the time from now to the predicted playing time of the next file download is sufficient to download the next file download completely. Therefore, the process further determines whether the next file download can be completely downloaded before the predicted playing time for the next file download (step S431). The determination may be achieved by the equation (1):

INVd+t0<t1.

Where INVd indicates the required time period for downloading a file, t0 indicates the current system time, and t1 indicates the predicted playing time of the next file download. When the equation (1) is satisfied, the playback application determines that the next file download can be completely downloaded before the predicted playing time of the next file download; otherwise, the playback application determines that the next file download cannot be completely downloaded before that time. It is to be understood that the predicted playing time of the next file download is the same as the refresh time of a new version of the second-layer playlist. INVd may be a pre-defined value, or a function varying with the current data download rate. For example, assume INVd is pre-defined as three seconds and the next refresh time for a new version of the second-layer playlist is “15:33:48”: If performing step S431 at “15:33:46”, then the playback application determines that the next file download cannot be completely downloaded before the predicted playing time for the next file download. Alternatively, if performing step S431 at “15:33:43”, then the playback application determines that the next file download cannot be completely downloaded before the predicted playing time for the next file download. When determining that the next file download cannot be completely downloaded before the predicted playing time for the next file download (the “no” path of step S431), the playback application waits until the next refresh time (step S451). When determining that the next file download can be completely downloaded before the predicted playing time for the next file download (the “yes” path of step S431), the playback application starts obtaining the next file download to be played (step S441) and playing the up-to-date file download (step S443).

Those skilled in the art would understood that, through the time synchronization performed by the live streaming broadcast server 130 (step S348) and each client (step S415), enabling the system times of the live streaming broadcast server 130 and each client to be consistent. Besides, all subscribing clients starting the next download and playing at the moment indicated by the parameter “EXT-EVENT-PLAYLIST-NEXT-BORN” makes different subscribing clients start to play the same file download at very close moments, thereby enabling the aforementioned inconsistency of playback progress among the subscribing clients can be reduced or eliminated.

Although the embodiment has been described as having specific elements in FIG. 2, it is noted that additional elements may be included to achieve better performance without departing from the spirit of the invention. While the process flows described in FIGS. 3A, 3B and 4 each include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for synchronization of a live streaming broadcast, executed by a processing unit of a live streaming broadcast server, comprising:
recording a refresh time of a new version of a second-layer playlist in the second-layer playlist; and
providing the second-layer playlist,
thereby enabling a client to start updating the second-layer playlist and download an up-to-date file download when time reaches the refresh time recorded in the second-layer playlist.

2. The method of claim 1, further comprising:
recording a generation time of the second-layer playlist in the second-layer playlist.

3. The method of claim 2, further comprising:
recording a first filename of a first file download currently being played in the second-layer playlist.

4. The method of claim 3, further comprising:
recording a second filename of a second file download available to be downloaded in the second-layer playlist,
thereby enabling the client to obtain the second file download, and, when time reaches the refresh time, start playing the second file download.

5. The method of claim 4, further comprising:
recording a third filename of a third file download available to be downloaded after the refresh time in the second-layer playlist,
thereby enabling the client to start downloading the third file download.

6. The method of claim 5, further comprising:
recording a network address of a NTP (Network Time Protocol) server in the second-layer playlist,
thereby enabling the client to adjust a system time of the client according to a timestamp acquired from the NTP server.

7. A method for synchronization of a live streaming broadcast, executed by a processing unit of a client, comprising:
obtaining a second-layer playlist from a live streaming broadcast server;
obtaining a refresh time recorded in the second-layer playlist; and
obtaining an up-to-date second-layer playlist from the live streaming broadcast server when time reaches the refresh time.

8. The method of claim 7, further comprising:
determining whether a file download to be played can be completely downloaded before the refresh time;
starting to download the file download from the live streaming broadcast server when it is determined that the file download can be completely downloaded before the refresh time; and
playing the file download when time reaches the refresh time.

9. The method of claim 8, further comprising:
waiting until the refresh time when it is determined that the file download cannot be completely downloaded before the refresh time.

10. The method of claim 9, further comprising:
obtaining a network address of a NTP (Network Time Protocol) server recorded in the second-layer playlist;
requesting a timestamp from the NTP server; and
adjusting a system time according to the timestamp before the determination step.

11. A system for synchronization of a live streaming broadcast, comprising:
a live streaming broadcast server, recording a refresh time of a new version of a second-layer playlist in the second-layer playlist, and providing the second-layer playlist, thereby enabling a client to start updating the second-layer playlist and download an up-to-date file download when time reaches the refresh time recorded in the second-layer playlist.

12. The system of claim 11, wherein the live streaming broadcast server further records a generation time of the second-layer playlist in the second-layer playlist.

13. The system of claim 12, wherein the live streaming broadcast server further records a first filename of a first file download being played currently in the second-layer playlist.

14. The system of claim 13, wherein the live streaming broadcast server further records a second filename of a second file download available to be downloaded in the second-layer playlist.

15. The system of claim 14, wherein the live streaming broadcast server further records a third filename of a third file download available to be downloaded after the refresh time in the second-layer playlist.

16. The system of claim 15, wherein the live streaming broadcast server further records a network address of a NTP (Network Time Protocol) server in the second-layer playlist.

17. The system of claim 11, further comprising:
the client, obtaining the second-layer playlist from a live streaming broadcast server, obtaining the refresh time recorded in the second-layer playlist, and obtaining the up-to-date second-layer playlist from the live streaming broadcast server when time reaches the refresh time.

18. The system of claim 17, wherein the client further determines whether a file download to be played can be completely downloaded before the refresh time, starts to download the file download from the live streaming broadcast server when it is determined that the file download can be completely downloaded before the refresh time, and plays the file download when time reaches the refresh time.

19. The system of claim 18, wherein the client further waits until the refresh time when it is determined that the file download cannot be completely downloaded before the refresh time.

20. The system of claim 19, wherein the client further obtains a network address of a NTP (Network Time Protocol) server recorded in the second-layer playlist, requests a timestamp from the NTP server, and adjusts a system time according to the timestamp before the determination.
